(19) United States
(12) Patent Application Publication
(10) Pub. No.: US 2008/0193221 A1
(43) Pub. Date: Aug. 14, 2008

(54) Reinforcing Materials For Repairing Underground Water Pipeline Without Excavation And Method For Repairing Thereof

(76) Inventors: Je Kun Lee, Gyeonggi-Do (KR); Seung Woo Shon, Gyeonggi-Do (KR)

Correspondence Address: GWIPS;Peter T. Kwon, Gwacheon P.O. Box 72, 119 Byeolyang Ro, Gwacheon City, Gyeonggi-Do, 427-600, omitted

(21) Appl. No.: 11/886,324

(22) PCT Filed: Mar. 15, 2006
(86) PCT No.: PCT/KR2006/000938

§ 371 Date: Sep. 12, 2007

(30) Foreign Application Priority Data
Mar. 16, 2005 (KR) 10-2005-0021834
Dec. 22, 2005 (KR) 10-2005-0128034

(51) Int. Cl. F16L 55/18

(52) U.S. Cl. 405/184.2

(57) ABSTRACT

A method and reinforcing materials are developed for repairing underground water pipeline without excavation. The reinforcing materials, which have forcibly rolled to form a cylindrical shape is inserted into the pipeline. Then, it will be expanded to tightly seal the damaged or cracked inner wall areas of the pipeline. A series of guiding belts are employed for circumferentially mounting on the outer surface of the reinforcing materials to form a sleeve. Thus, it is smoothly inserted into the water pipeline by pulling one end. Once the sleeve is inserted into the pipeline, the sleeve is steadily expanded to seal and tighten the damaged area. Accordingly, the repair work is easily facilitated to seal the damaged area of the pipeline without excavation. The repair materials have formed as a simple sleeve with smooth inner surface for minimizing the finishing process, such as a cutting. Thereby, the leakage is efficiency prevented without disconnecting the water supply.

### TECHNICAL FIELD

The present invention relates to a non-excavating repair materials of a pipe and repair method. More particularly, the present invention relates to a non-excavating repair materials of a pipe, capable of facilitating the repairing work by being stably expanded and secured, and guaranteeing high reliability of stopping water without interfering with the flow of water by having a smooth inner surface simply structured through minimum processes, and the repairing method using the same.

### BACKGROUND ART

In general, a non-excavating repair material supplements various damaged parts of a water pipe being laid underground, such as partial breakage, a gap at a connection part, a step and the likes that may induce leakage of water. Usually, such a repair material is contractedly rolled up in a cylindrical form until being inserted in a water pipe and expanded in the water pipe to tightly contact with an inside of the water pipe having damaged parts or cracks.

In order to non-excavatingly repair the inside of the underground pipe, various methods can be adopted: an overall repair method that inserts a synthetic resin pipe in the whole section having the damaged parts; a partial lining repair method that repairs only the damaged part using an adhesive resin solution and a glass fiber, more particularly by impregnating the glass fiber with the adhesive resin solution and hardening the adhesive resin with only respect to the damaged part; an improved partial lining repair method that additionally uses a stainless steel plate cylindrically rolled up to be inserted in the repair material as a reinforcing support pipe besides the adhesive resin solution and the glass fiber; and a reinforcement ring method that mounts a cylindrically rolled stainless steel plate in tight contact with the inside of the water pipe.

Among the above, the reinforcement ring method using a non-excavating repair material is widely used for non-excavating repair since it requires relatively short time and simple processes. However, improvement in the non-excavating repair material has been in urgent demand.

FIG. 1 is a perspective view for explaining a conventional non-excavating repair material.

As shown in the drawing, the conventional non-excavating repair material comprises a cylindrically rolled sleeve 10 made of stainless steel. The sleeve 10 includes locking protrusions 11 at one end of an outer surface thereof, which are interfered with the other end when the sleeve 10 is contracted after being expanded, to prevent the expanded sleeve 10 from contracting.

A method for repairing a water pipe P using the repair material will be briefly explained hereinafter.

First, the sleeve 10 is mounted on the outside of a repair tool 30 having an airbag form, a tool body 31 of which is inflated by air injection. Here, the tool body 31 of the repair tool 30 is in a deflated state, and the sleeve 10 is in a cylindrically contracted form. A rubber ring 20 is attached to the outside of the sleeve 10 to tighten the sleeve 10 by a proper degree of force. More specifically, the rubber ring 20 helps not only the sleeve 10 maintain the cylindrical form during contraction and expansion but also the locking protrusions 11 be securely engaged with the other end of the sleeve 10 after the sleeve 10 is expanded.

Next, the repair tool 30 mounted with the sleeve 10 is inserted in the water pipe P and disposed at a part in need of repairs. The tool body 31 is inflated by injecting air into the repair tool 30. Accordingly, the sleeve 10 in a contracted state is expandingly rolled out, thereby being tightly contacted with an inner wall of the water pipe P.

Then, the tool body 31 is deflated and the repair tool 30 is separated from the sleeve 10 and drawn out from the water pipe P. Although being apt to shrink due to its resilient recovery force, the sleeve 10 can be in tight contact with the inner wall of the water pipe P, as expanded, by the locking protrusions 11 engaged with the other end of the sleeve 10. Thus, mounting of the sleeve 10 for repairing the water pipe P is completed. If necessary, a process for further biasing the sleeve 10 toward the water pipe P may be added.

In the conventional repair material, however, expansion of the repair material and restriction by the locking protrusions 11 are not ensured without the rubber ring 20 that encloses the outer surface of the material by a predetermined force. Therefore, at least two rubber rings 20 are necessitated in the conventional repair material.

In addition, since merely any one of the locking protrusions 11 is engaged with the other end of the sleeve 10 in the conventional repair material, the restriction by the locking protrusions 11 is not sufficient. Therefore, there has been a problem with the conventional repair material in that the restriction by the locking protrusions 11 can easily be released after the repair material is mounted in the water pipe P. Such a problem is generated especially as the sleeve 10 is applied with a certain force directly or indirectly by a variety of environmental factors such as dredging construction.

Furthermore, direct cut on the sleeve 10 for formation of the locking protrusions 11 could cause serious problems. For example, unevenness of an inner surface of the sleeve 10 hinders smooth flow of water. Moreover, water may leak from the cut portion, thereby deteriorating reliability of stopping water.

### DISCLOSURE OF INVENTION

### Technical Problem

Therefore, the present invention has been made in view of the above-mentioned problems, and it is an object of the present invention to provide a non-excavating repair material for a pipe capable of facilitating repairing work and guaranteeing high reliability of stopping water, and a repairing method using the same.

### Technical Solution

In order to achieve an object of the present invention, there is provided a non-excavating repair materials of a pipe, being inserted in the water pipe in a cylindrically rolled form and expanded to be tightly contacted with a damaged or cracked portion on an inner wall of the water pipe, comprising a sleeve having resilience for spreading to its initial form when being rolled up; and a guide belt circumferentially mounted to an outer surface of the sleeve to guide an end of the sleeve in a sliding manner.

The sleeve comprises at one end thereof a cut part for the guide belt to penetrate through, and the guide belt is welded to the outer surface of the sleeve by only both ends thereof so that a sliding section is formed between the welded ends for the one end of the sleeve to slide along.

The guide belt comprises a plurality of locking protrusions formed along a length direction for engagement with the one end of the sleeve to prevent the sleeve once expanded from contracting back.

The one end of the sleeve engaged with the locking protrusion is partly curved to protruded outward.

The locking protrusion is formed by partially cutting the guide belt in a trapezoid shape and bending the cut portion inwardly to face the one end of the sleeve.

A locking bar is attached on the end of the outer surface of the sleeve, the end contacted with the guide belt right before the guide belt passes through the cut part, thereby constituting a part of the end of the sleeve 100.

The guide belt comprises a plurality of catch holes formed along a length direction, and the sleeve comprises a locking piece protruded from one end thereof to be engaged with the catch holes and restrain the expanded sleeve from contracting back.

The one end of the sleeve where the locking piece is formed is partly curved to protrude out.

The sleeve has a guide line recessedly formed on an outer surface thereof along a length direction.

The guide belt is disposed within the guide line.

The sleeve comprises a plurality of corrugations formed on the outer surface in a circumferential direction.

The sleeve is attached with a sealing-type water stopping material formed of rubber around the outer surface thereof.

Lateral edges of the sleeve are sloped outward so that a diameter of the sleeve increases toward the lateral edges.

The guide belt comprises a plurality of catch holes formed along a length direction, and the sleeve comprises a locking member attached to one end of the outer surface thereof to be engaged with the catch holes and restrain the expanded sleeve from contracting back.

The locking member is engaged with the catch holes from the outside of the guide belt.

The locking member is formed by extending one end of the guide belt.

The sleeve comprises a plurality of corrugations formed on the outer surface in a circumferential direction, an air discharge hole, and chemicals injection hole.

Another aspect of the present invention is to provide a repairing method using a non-excavating water pipe repair material being inserted in the water pipe in a cylindrically rolled form and expanded to be tightly contacted with a damaged or cracked portion on an inner wall of the water pipe, and comprising a sleeve having resilience for spreading to its initial form when being rolled up and including a plurality of corrugations formed in a circumferential direction of the sleeve, and a guide belt circumferentially mounted to an outer surface of the sleeve to guide an end of the sleeve in a sliding manner, the method mounting the repair material inside the water pipe by expanding the sleeve on a damaged part of the water pipe in need of the repair, and injecting into a gap between the sleeve and the inner wall of the water pipe and hardening a water-stopping and strength-reinforcing chemicals.

The repairing method comprises the steps of boring the sleeve of the repair material, thereby preparing an air discharge hole and the chemicals injection hole; mounting the repair material on the outside of a repair tool having an inflatable tool body; fitting o-rings around both outer ends of the sleeve to seal the gap between the sleeve and the inner wall of the water pipe; moving the repair tool with the repair material mounted to the tool body to the damaged part of the water pipe; mounting the repair material in the water pipe by inflating the tool body; injecting the chemicals into the gap between the sleeve and the inner wall of the water pipe through the chemicals injection hole; and hardening the injected chemicals.

### Advantageous Effects

As described above, according to the non-excavating repair material for a pipe of the present invention, separation between one and the other ends of a sleeve, which are superposed as the sleeve is rolled up, can be prevented using a guide belt without assistance of an auxiliary member such as a rubber ring used in the conventional art.

In addition, contraction and expansion of the sleeve can be stably and accurately performed by the guide belt without the auxiliary member such as the rubber ring.

In addition, when a curve part, which is partially curved, is provided to the other end of the sleeve, locking protrusions and locking pieces can be engaged more securely.

Additionally, after the sleeve is expanded, the locking protrusions formed at the guide belt can be more securely engaged by a locking bar attached to the outer surface of the other end of the sleeve.

Furthermore, since an inner surface of the sleeve is almost unprocessed and therefore smooth, the flow of water is not hindered much, thereby guaranteeing reliability of stopping water.

Furthermore, since a corrugation protruded on the outer surface of the sleeve can seal even stepped gaps among the water pipes, a connection part between two water pipes or an irregularly structured part of the water pipe can be easily repaired.

Moreover, a sealing-type water stopping material welded to the outer surface of the sleeve is not highly affected by expansion of the sleeve. Accordingly, lifespan of the water stopping material and the water stopping efficiency can be improved.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a perspective view illustrating a non-excavating repair material for a pipe, according to a conventional art;

FIG. 2 is a view for showing the non-excavating repair material according to a first embodiment of the present invention in use;

FIG. 3 is a perspective view of the first embodiment of the present invention;

FIG. 4 is an exploded perspective view of the first embodiment of the present invention;

FIG. 5 is a sectional view of the first embodiment of the present invention;

FIGS. 6 and 7 are reference views for explaining the operations of mounting a repair material according to the first embodiment in a water pipe;

FIG. 8 is an exploded perspective view illustrating the repair material according to the first embodiment further comprising a sealing-type water stopping material;

FIG. 9 is a perspective view illustrating the repair material according to the first embodiment further comprising a locking bar;

FIG. 10 is an exploded perspective view for explaining the repair material according to the first embodiment further comprising the locking bar;

FIG. 11 is a perspective view of a repair material according to a second embodiment of the present invention;

FIG. 12 is a sectional view of the repair material according to the second embodiment of the present invention;

FIG. 13 is a perspective view of a repair material according to a third embodiment of the present invention;

FIG. 14 is an exploded perspective view of the repair material according to the third embodiment of the present invention;

FIG. 15 is a sectional view of the repair material according to the third embodiment of the present invention;

FIG. 16 is a perspective view of a repair material according to a fourth embodiment of the present invention;

FIG. 17 is an exploded perspective view of the repair material according to the fourth embodiment of the present invention;

FIG. 18 is a sectional view of the repair material according to the fourth embodiment of the present invention;

FIG. 19 is a perspective view of a repair material according to a fifth embodiment of the present invention; and

FIGS. 20 through 22 are reference views for explaining a repairing method using the repair material according to the fifth embodiment of the present invention.

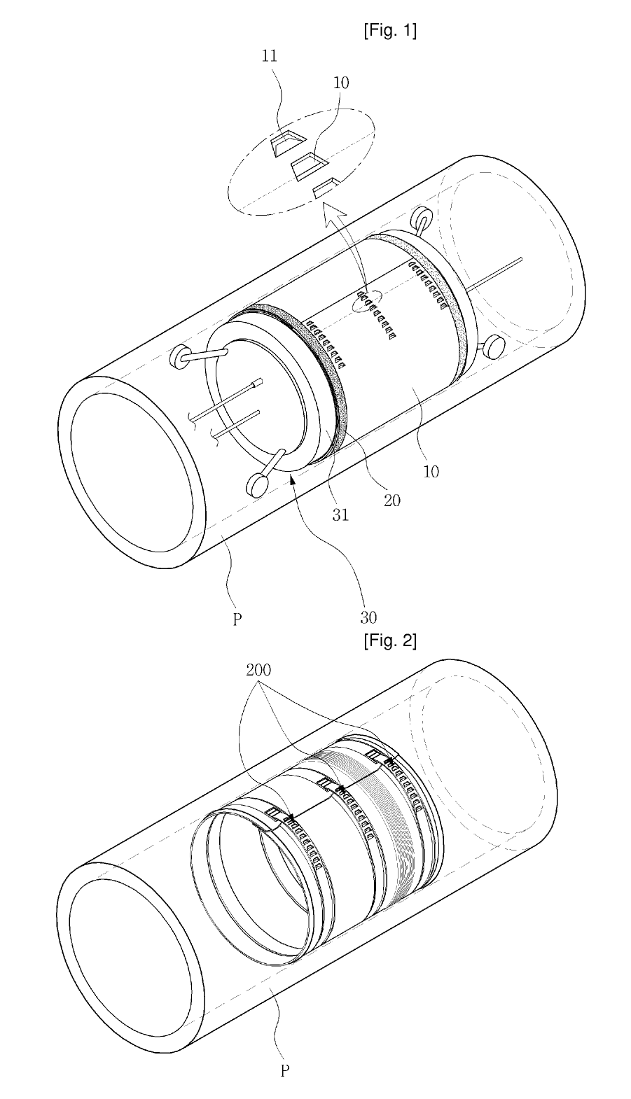

### BEST MODE FOR CARRYING OUT THE INVENTION

Reference will now be made in detail to the preferred embodiments of the present invention.

### First Embodiment

FIG. 2 is a view showing a non-excavating repair material for a pipe according to a first embodiment of the present invention, in use.

As shown in the drawing, the non-excavating repair material according to the first embodiment of the present invention is contractedly rolled up in a cylindrical form until being inserted in a water pipe P and then expanded in the water pipe P. Thus, the repair material is tightly contacted with an inside of the water pipe P in need of repair on breakage or cracks.

According to the present invention, contracting and expanding operations of the repair material can be achieved stably and accurately through a guide belt 200, without assistance of an auxiliary member such as a rubber ring. Furthermore, once being expanded, the repair material is not contracted again but securely mounted in the water pipe P. Also, the repair material of the present invention is configured to improve reliability of water stopping without hindering smooth flow of water when mounted in the water pipe P.

Hereinafter, the structure of the non-excavating repair material for a pipe according to a first embodiment of the present invention will be described in greater detail.

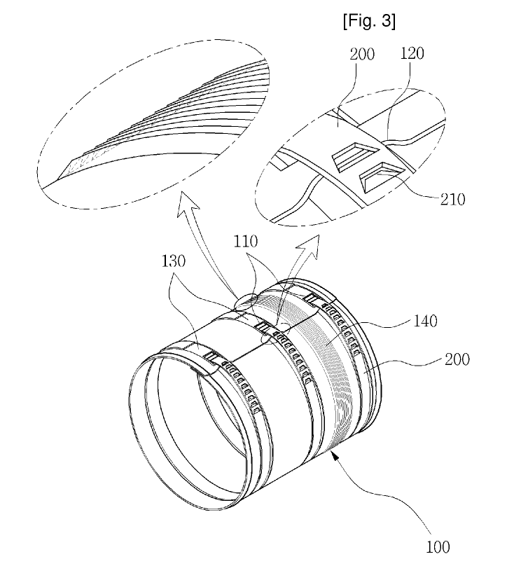

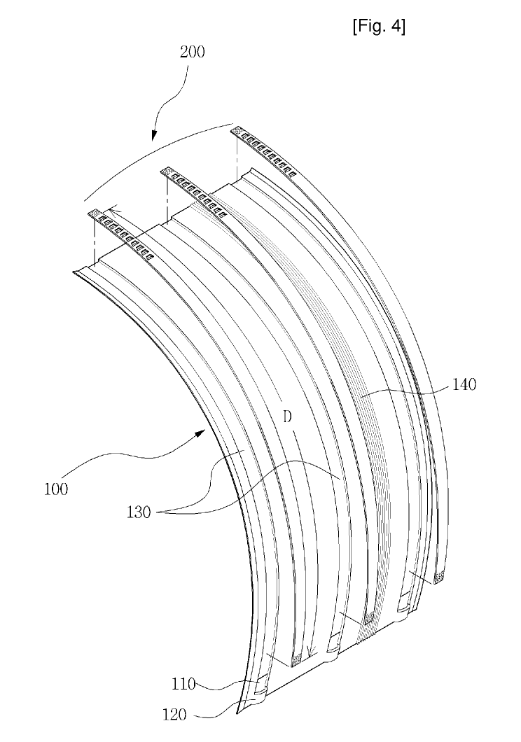

FIG. 3 is a perspective view of the first embodiment of the present invention, FIG. 4 is an exploded perspective view of the first embodiment of the present invention, and FIG. 5 is a sectional view of the first embodiment of the present invention.

Referring to the drawings, the first embodiment of the present invention comprises a sleeve 100, and a guide belt 200 for controlling contraction and expansion of the sleeve 100 stably and accurately.

The sleeve 100 is made of a material having resilience of tending to return to an initial state when being rolled up. Also, the material for the sleeve 100 is corrosion-resisting. Any material satisfying the above, such as stainless steel, is appropriate for the sleeve 100. The sleeve 100 has thickness for resiliently rolling up and out. A cut part 110 for penetrating therein the guide belt 200 is formed at one end of the sleeve 100 to guide the guide belt 200 while the sleeve 100 is contracting and expanding.

A curve part 120 is protrudedly formed along the one end of the sleeve 100, more particularly, where locking protrusions 210 of the guide belt 200 are engaged. The curve part 120 helps the sleeve 100 more tightly contact with the guide belt 200, thereby enabling the locking protrusions 210 to be engaged with the one end of the sleeve 100 more securely.

A guide line 130 is formed recessedly along an outer circumference of the sleeve 100. The guide line 130 exerts a predetermined force for maintaining a shape of the sleeve 100. Since being recessed from an outer surface and protruded from an inner surface of the sleeve 100, both ends of the guide line 130 can correspond to each other as one end of the sleeve 100 is superposed with the other end. Therefore, additionally, the guide line 130 has a function of preventing the both ends of the sleeve 100 in a rolled state do not move away from each other. In addition, since the guide belt 200 is provided in the guide line 130, the guide belt 200 can be less protruded on the sleeve 100 when mounted. Also, the locking protrusions 210 formed at the guide belt 200 can be fastened to the one end of the sleeve 100 more securely.

The sleeve 100 comprises a corrugation 140 formed on the outer circumference thereof. The corrugation 140 is formed by partially folding the sleeve 100 using a formation roller (not shown) to protrude outward. Such corrugation 140 is useful especially when two water pipes are connected with each other in a stepped manner. More specifically, after the corrugation 140 is positioned right at the connecting portion of the two pipes, when the repair material is mounted and an inner surface of the corrugation 140 is strongly spread, the stepped portion between the two water pipes can be filled up by the protruded corrugation 140. As described above, the repair material can be easily mounted even in the stepped portion owing to the corrugation 140. Width of the corrugation 140 is not limited specifically. Therefore, the corrugation 140 may be formed throughout the sleeve 100. However, the sleeve 100 of the present invention is not limited to have the corrugation 140, so that the sleeve 100 with the corrugation 140 is applied to a stepped connecting portion and the sleeve 100 without the corrugation to the other portion.

Lateral edges of the sleeve 100 are sloped outward by a predetermined angle, so that the sleeve 100 can be tightly contacted with the inside of the water pipe P, enduring thickness of the protruded part of the guide belt 200 mounted on the outside thereof.

The guide belt 200 is mounted along an outer circumference of the sleeve 100 to guide sliding of one end of the sleeve 100 along the outer circumference as the sleeve 100 being rolled up contracts and expands. The guide belt 200 is mounted basically on one outer end of the sleeve 100 but may be mounted throughout the whole sleeve, that is, from the one outer end up to the other outer end.

The structure of the guide belt 200 will now be explained in greater detail. Both ends of the guide belt 200 are welded circumferentially to the outer surface of the sleeve 100, as penetrating the cut part 110 formed at one end of the sleeve 100. Therefore, whereas the both ends of the guide belt 200 are welded to the surface of the sleeve 100, a non-welded section between the both ends becomes a sliding section D where the one end of the sleeve 100 slides along. The number of the guide belt 200 varies according to width of the sleeve 100. Length of the guide belt 200 exceeds a little a sliding distance of the sleeve 100. By help of the guide belt 200, the rolled-up state of the sleeve 100 can be maintained without an auxiliary member such as a rubber ring. In addition, contraction and expansion of the sleeve 100 can be more stabilized when the one end of the sleeve 100 slides along the outer circumference of the sleeve 100, especially, the other end part of the sleeve 100.

A plurality of locking protrusions 210 for engagement with the other end of the sleeve 100 are formed on the guide belt 200 along a length direction to prevent the sleeve 100 once expanded from contracting back. The locking protrusions 210 are formed by partially cutting the guide belt 200 in a trapezoid or a semicircular shape and bending the cut portion inwardly. Preferably, the cut portions are bent by approximately 30˜45 for secure engagement with the other end of the sleeve 100. Also, the locking protrusions 210 need to direct one end of the sleeve 100 so as to be engaged only when the sleeve 100 is contracted, not when the sleeve 100 is expanded. The above structure of the locking protrusions 210 linearly arranged in the length direction of the guide belt 200 enables the sleeve 100 to be restricted in various expanded degrees, so that the repair material can be facilely mounted in the water pipe P having various diameters. After the sleeve 100 is expanded and mounted in the water pipe P, the locking protrusions 210 are securely engaged with the other end of the sleeve 100, thereby preventing re-contraction of the sleeve 100.

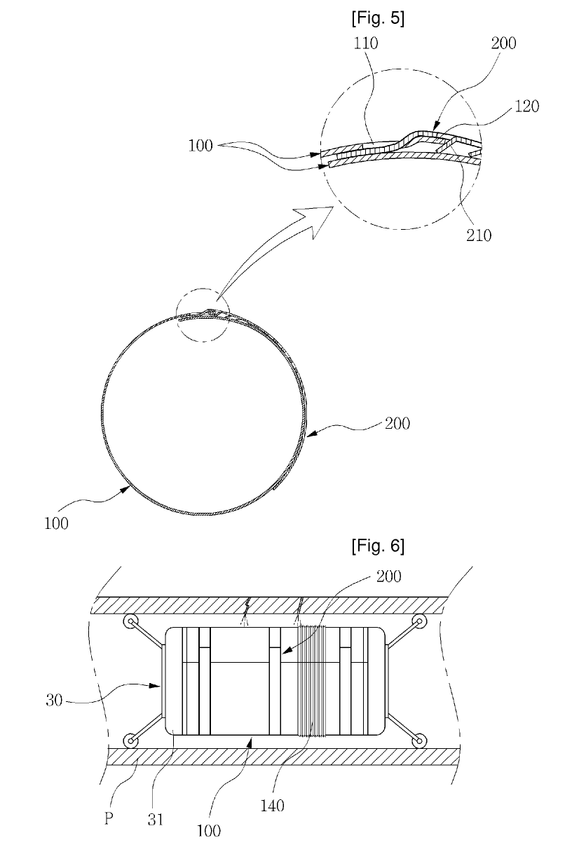

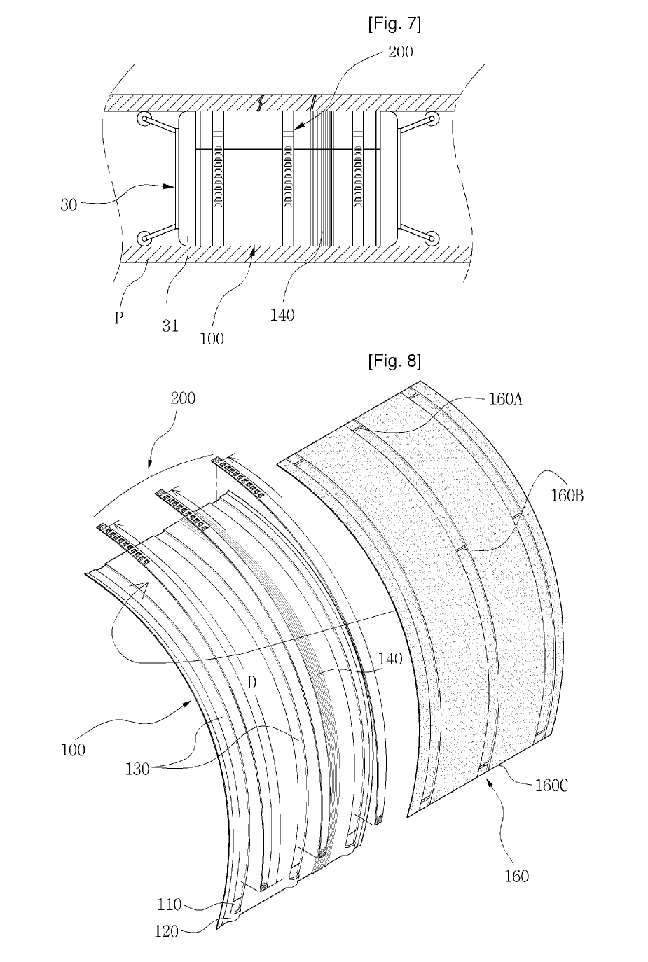

Hereinafter, the mounting processes for the repair material according to a first embodiment of the present invention will be described with reference to FIGS. 6 to 7.

First, a repair tool 30 having an elastic tool body 31 is necessary for mounting of the repair material inside the water pipe P. Any element can be applied for the repair tool 30 as long as it is capable of placing and expanding the repair material on a part to be repaired inside the water pipe P. In explaining the embodiment of the present invention, a tube-type repair tool 30 which is inflated by air injection is adopted.

The repair material according to the embodiment of the present invention is mounted to an outer surface of the tool body 31 of the repair tool 30. In this state, the tool body 31 and the sleeve 100 are contracted, and the contracted states are maintained by the guide belt 200 without an auxiliary member such as the rubber ring formed on the outer surface. Thus, after being mounted to the tool body 31 of the repair tool 30, the repair material is inserted in the water pipe P and positioned correctly where the repair is required.

Next, the tool body 31 of the repair tool 30 expanded and accordingly, the sleeve 100 is expanded. During this, an end of the sleeve 100 is slid toward the other end along the guide belt 200 penetrating the cut part 110. Here, since the locking protrusions 210 protruded on the guide belt 200 are inclined in a direction the one end of the sleeve 100 is moved, the movement of the one end is not interfered by the locking protrusions 210. Furthermore, when the both ends of the sleeve 100 are superposed on each other, the guide line 130 recessed on the surface of the sleeve 100 restrains the both ends from escaping from each other. Thus, as being expanded more and more, the sleeve 100 can be tightly contacted with the inner wall of the water pipe P.

The corrugation 140 protruded on the sleeve 100 is compressed when the sleeve 100 is brought in tight contact with the inner wall of the water pipe P. Although not shown, the corrugation 140 is optimized especially when the connection part between water pipes P is stepped since the corrugation can seal the gap of the stepped portion. For tight contact of the sleeve 100 with the inner wall of the water pipe P, dedicated tools such as a pressurizing roller (not shown) can be additionally employed.

Afterwards, the repair tool 30 contracts the tool body 31, thereby separating the tool body 31 from the sleeve 100, and pulls the tool body 31 out of the water pipe P. Therefore, only the repair material remains in the water pipe P, as tightly contacted with the inner wall of the water pipe P. Thus, mounting of the repair material is completed. Although the sleeve 100 is apt to contract to its initial state according to contraction of the tool body 31, the locking protrusions 210 of the guide belt 200, being engaged with the other end of the sleeve 100, helps the sleeve 100 maintain the expanded state.

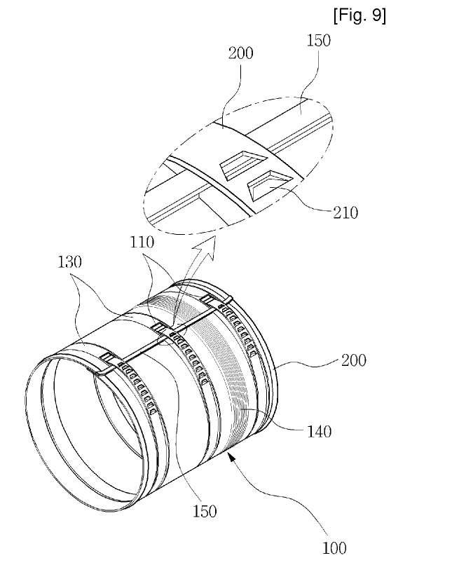

FIG. 8 is an exploded perspective view for explaining a repair material further comprising a sealing-type water stopping material, according to a first embodiment of the present invention.

As shown in FIG. 8, a sealing-type water stopping material 160 can be further provided to the outer surface of the sleeve 100.

The sealing-type water stopping material 160 can be formed of one of various materials having a waterproof or water-stopping effect, such as foamed rubber. The sealing-type water stopping material 160 has thickness of approximately 10˜20 mm and comprises small holes 161A, 161B and 161C for penetration by the guide belt 200.

The sealing-type water stopping material 160 formed as a plate and welded to the outer surface of the sleeve 100 solves problems of a conventional water stopping material which merely encloses a rolled-up sleeve. More specifically, the conventional water stopping material is separately formed in a cylindrical shape and fit around the outer surface of the sleeve being cylindrically contracted. As the sleeve is expanded, the conventional water stopping material is also expanded tightly, thereby becoming thin and fragile. Therefore, the conventional water stopping material is easily damaged when or after being mounted in the water pipe P, thereby deteriorating the waterproof or water-stopping effect. However, the sealing-type water stopping material 160 according to the embodiment of the present invention removes such a problem.

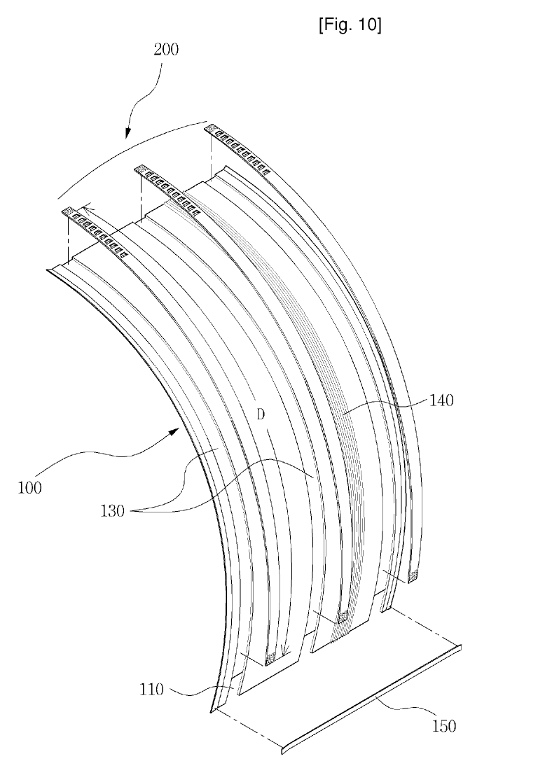

FIG. 9 is a perspective view illustrating the repair material according to the first embodiment further comprising a locking bar. FIG. 10 is an exploded perspective view for explaining the repair material according to the first embodiment further comprising the locking bar.

As shown in the drawings, a locking bar 150 can be additionally formed at the one end of the sleeve 100. The locking bar 150 is attached on the end of the outer surface of the sleeve 100, where is contacted with the guide belt 200 right before the guide belt 200 passes through the cut part 110. Thus, constituting a part of the end of the sleeve 100, the locking bar 150 restrains the expanded sleeve 100 from contracting back, in association with the locking protrusions 210. Because the locking bar 150 is slightly protruded out on the outer surface of the sleeve 100, contact between the locking bar 150 and the guide belt 200 is reinforced, accordingly securing the engagement with the locking protrusions 210.

### Mode for the Invention

Other embodiments of the present invention will now be described.

### Second Embodiment

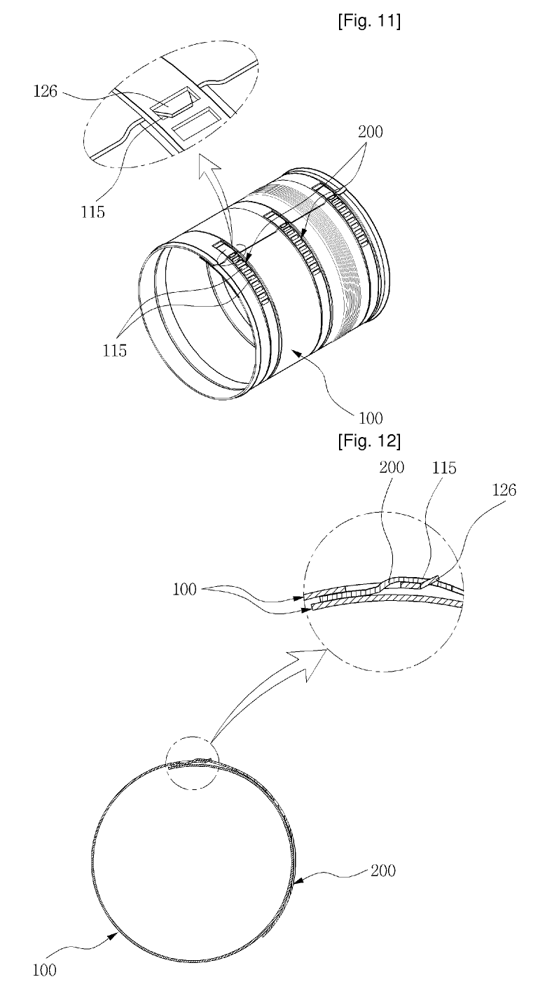

FIG. 11 is a perspective view of a repair material according to a second embodiment of the present invention. FIG. 12 is a sectional view of the repair material of the second embodiment.

As shown in the drawings, the repair material of the second embodiment comprises a plurality of catch holes 115 formed on the guide belt 200 in a length direction. In addition, a locking piece 126 is formed at one end of the sleeve 100 to be engaged with the catch holes 115 when the sleeve 100 is expanded.

The locking piece 126 is slantingly protruded, facing the other end of the sleeve 100, in order to be engaged with the catch holes 115 not when the sleeve 100 is expanded, but only when the sleeve 100 once expanded is contracted. The end of the sleeve 100 where the locking piece 126 is formed is partly curved to protrude outward, so that the locking piece 126 can be caught by the catch holes 115 more securely.

Since the other constitutional elements of the sleeve 100, including the corrugation 140, are the same as those in the first embodiment, detailed description thereof will be omitted.

### Third Embodiment

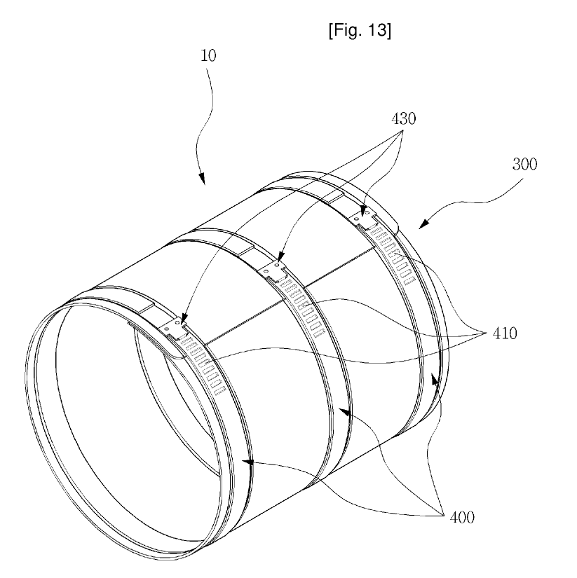

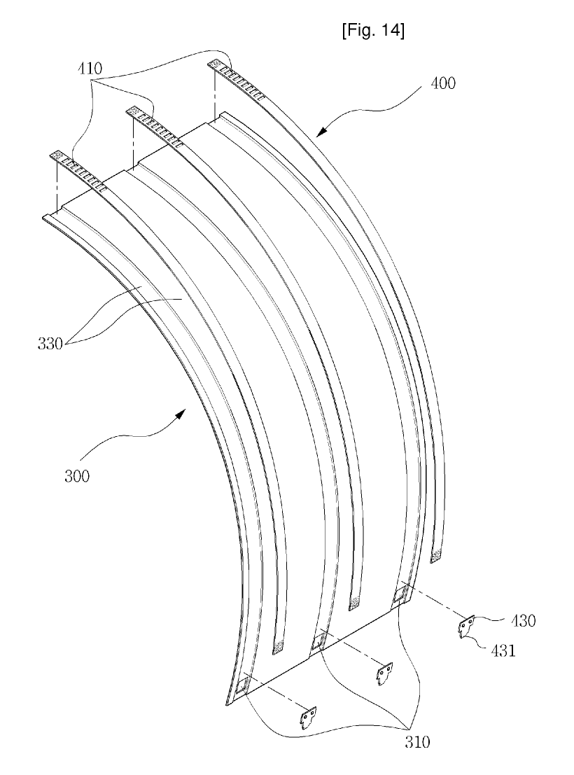

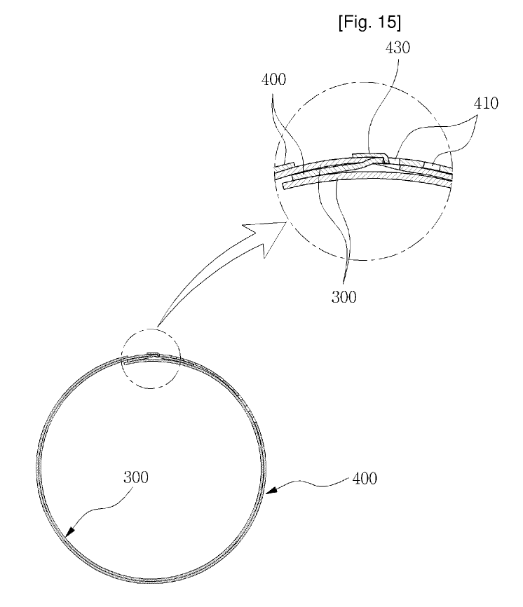

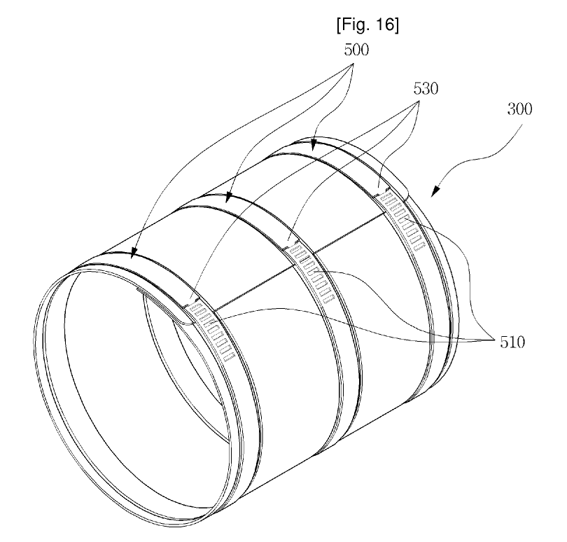

FIG. 13 is a perspective view of a repair material according to a third embodiment of the present invention, FIG. 14 is an exploded perspective view of the repair material according to the third embodiment, and FIG. 15 is a sectional view of the repair material according to the third embodiment.

Referring to the drawings, the repair material of the third embodiment also comprises a sleeve 300 and a guide belt 400 for guiding more stable and accurate expansion/contraction of the sleeve 300.

The sleeve 300 is made of a corrosion-resisting and resilient material apt to spread to its initial state when being rolled up. In other words, any material can be used for the sleeve 300 as long as satisfying the above conditions. For example, stainless steel is appropriate for the sleeve 300. The sleeve 300 has thickness for smoothly contracting and expanding. A cut part 310 for penetrating therein the guide belt 400 is formed at one end of the sleeve 300 to guide the guide belt 400 while the sleeve 300 is contracting and expanding.

In the same manner as the first embodiment, a guide line 330 is recessedly formed on an outer surface of the sleeve 300 in a length direction.

The guide belt 400 is mounted circumferentially on the outer surface of the sleeve 300. Accordingly, while the sleeve 300 is contracting and expanding in a rolled-up state, the one end of the sleeve 300 can be guided in a sliding manner along the other end part of the outer circumference of the sleeve 300.

The structure of the guide belt 400 will now be described in greater detail. In a state that the guide belt 400 penetrates the cut part 310 formed at the one end of the sleeve 300, both ends of the guide belt 400 are welded circumferentially to the outer surface of the sleeve 300. Therefore, whereas the both ends of the guide belt 400 are welded with the surface of the sleeve 300, a non-welded section between the both ends becomes a sliding section for the one end of the sleeve 300 to slide along. The number of the guide belt 400 varies according to width of the sleeve 300. For example, three guide belts 400 may be provided on both ends and in the middle of the sleeve 300 as shown in the drawing. However, when the width of the sleeve 300 is greater, four or more guide belts 400 can be employed. Length of the guide belt 400 exceeds a little a sliding distance of the sleeve 300. By help of the guide belt 400, the rolled-up state of the sleeve 300 can be maintained without an auxiliary member such as a rubber ring dedicatedly provided. In addition, contraction and expansion of the sleeve 300 can be more stabilized when the one end of the sleeve 300 slides along the outer circumference of the sleeve 300, especially, the other end part of the sleeve 300.

A plurality of catch holes 410 for restricting a locking member 430 formed at the one end of the sleeve 300 are arranged on the guide belt 400 in a length direction. The plural number of the catch holes 410 enables the sleeve 300 to be restricted in various degrees of expanded state, so that the repair material can be facilely mounted in the water pipe P having various diameters. After the sleeve 300 is expanded and mounted in the water pipe P, the locking member 430 are securely engaged with the catch hole 410 of the sleeve 300, thereby restraining re-contraction of the sleeve 300.

The locking member 430 is formed at one end of the sleeve 300 and comprises a stoop part 431 bent inward for engagement with the catch hole 410 of the guide belt 400. Assuming that a side of the cut part 310 near the one end of the sleeve 300 is a front side, the locking member 430 is formed near a rear side of the cut part 310, directing the end of the sleeve 300. The stoop part 431 is bent by approximately 30˜45 inwardly. According to this structure, the locking member 430 is not caught by the catch hole 410 when the sleeve 300 is expanded but caught only when the sleeve 300 is contracted back from the expanded state, thereby restricting contraction of the sleeve 300. Furthermore, the inwardly formed stoop part 331 does not cause unnecessary protrusion on the locking member 430.

Both ends of the sleeve 300 may be sloped outward by a predetermined angle for more tight contact with the outside of the repair tool 30.

### Fourth Embodiment

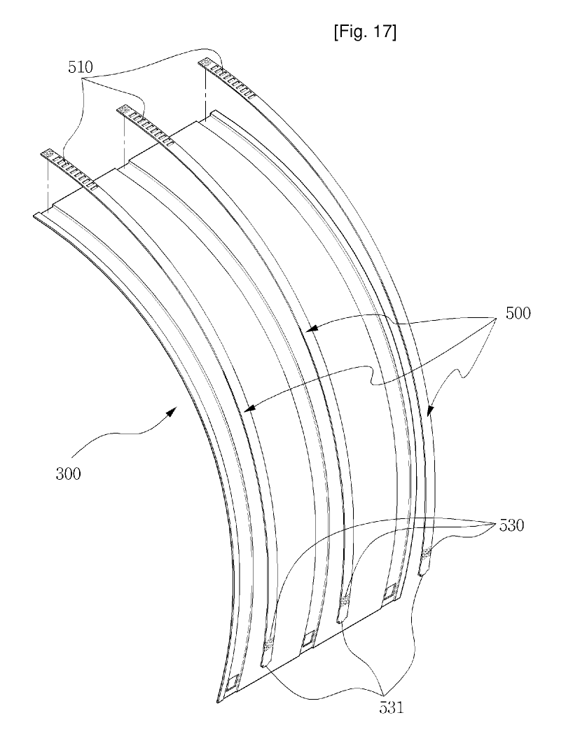

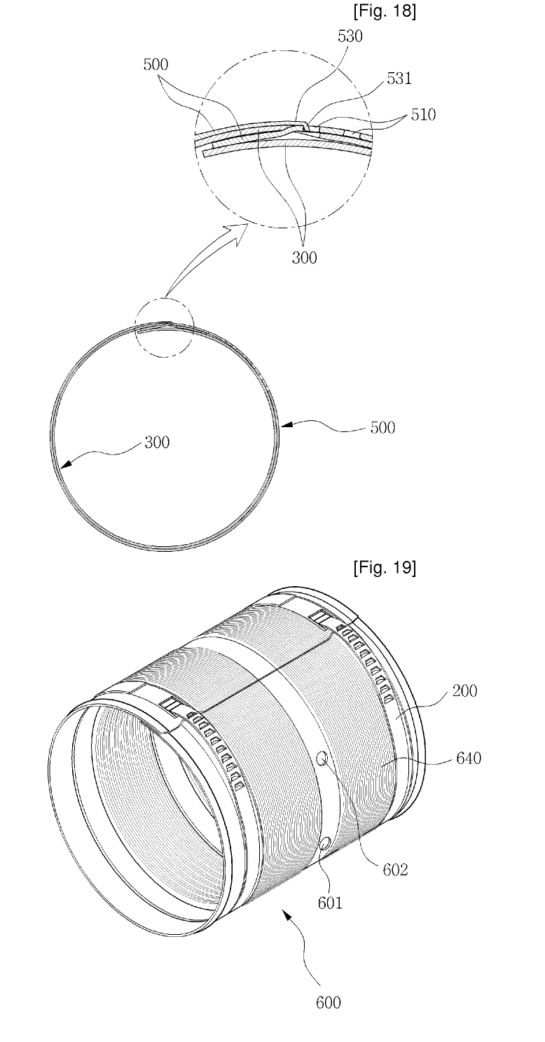

FIG. 16 is a perspective view of a repair material according to a fourth embodiment of the present invention, FIG. 17 is an exploded perspective view of the repair material according to the fourth embodiment, and FIG. 18 is a sectional view of the repair material according to the fourth embodiment.

Referring to the drawings, compared to the third embodiment, one end of a guide belt 500 of the fourth embodiment is more extended, and a locking member 530 having a stoop part 531 is integrally formed with the extended end.

Differently from the third embodiment, according to the fourth embodiment having the locking member 530 integrally formed with the end of the guide belt 500, processes of separately producing and connecting the locking member can be omitted. In other words, the guide belt 500 can be mounted saving the number of parts and producing and assembling processes.

### Fifth Embodiment

FIG. 19 is a perspective view of a repair material according to a fifth embodiment of the present invention.

As shown in FIG. 19, differences of the fifth embodiment from the first embodiment is that a corrugation 640 is formed through the whole outer surface of a sleeve 600 in a circumferential direction, and the sleeve 600 comprises chemicals injection hole 601 and an air discharge hole 602. The other structures of the present embodiment, including the guide belt 200, are almost the same as those of the first embodiment.

The repair material according to the fifth embodiment is especially useful when a connection part between water pipes is stepped, when water pipes are irregularly formed, and when a gap is inevitably generated between the repair material and an inner wall of the water pipe.

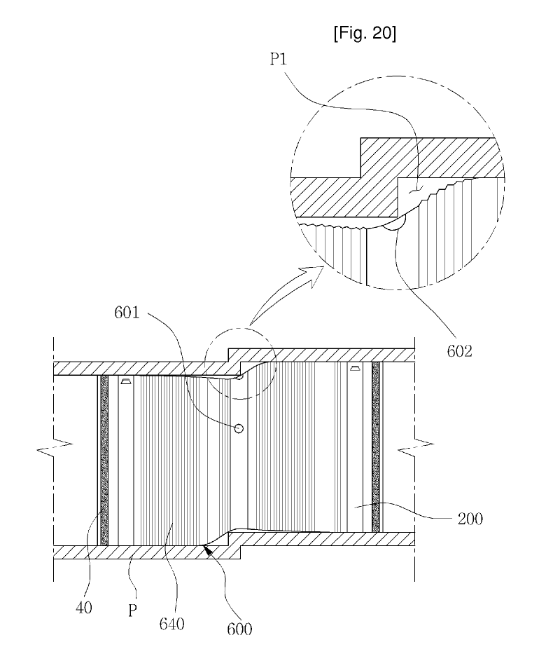

Hereinafter, a repairing method using the non-excavating repair material according to the fifth embodiment will be described specifically with reference to FIGS. 20 through 22. FIGS. 20 through 22 are reference views for explaining a repairing method using the repair material according to the fifth embodiment of the present invention.

The repairing method of the present invention is optimized when repairing a stepped portion connecting two water pipes P, when repairing the water pipe P having an irregular form, and when a gap P1 is generated between the repair material and the inner wall of the water pipe P.

First, the repair material having the densely corrugated sleeve 600 is mounted on an outside of the repair tool 30 having an inflatable body, as shown in FIGS. 6 and 7. The sleeve 600 of the repair material needs to include the chemicals injection hole 601 and the air discharge hole 602. The repair material according to the fifth embodiment of the present invention already comprising the chemicals injection hole 601 and the air discharge hole 602 does not require a dedicated boring process.

A pair of o-rings 40 for sealing are fit around both outer ends of the sleeve 600.

The repair tool 30 with the repair material mounted thereto is moved to a damaged part of the water pipe P in need of the repair. In this state, the tool body 31 of the repair tool 30 is not fully inflated so as to be smoothly moved inside the water pipe P.

After the repair tool 30 is positioned correctly on the damaged part in the water pipe P, the tool body 31 is inflated. Accordingly, the sleeve 600 of the repair material is expanded and brought into tight contact with the inner wall of the water pipe P, as shown in FIG. 20. However, the gap P1 is generated around the stepped portion between the sleeve 600 and the inner wall of the water pipe P.

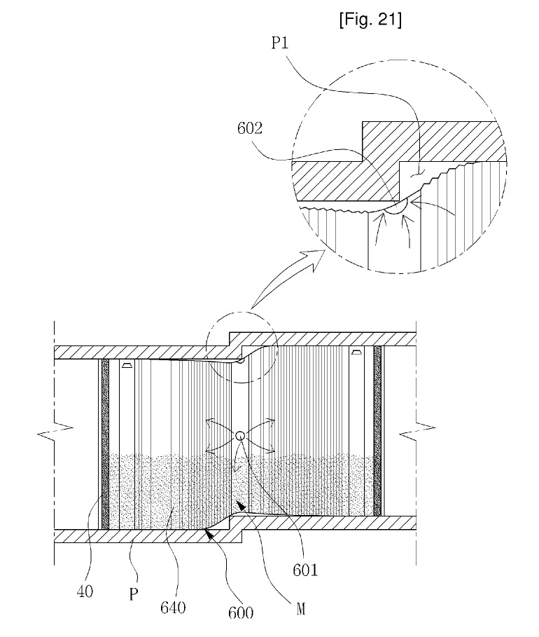

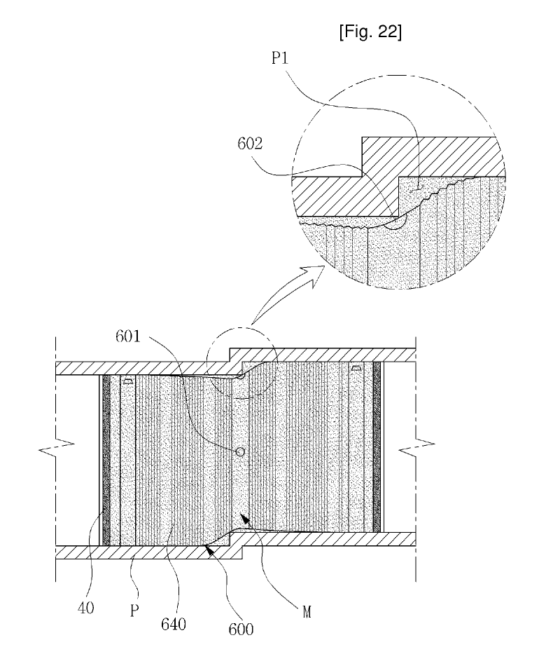

As shown in FIG. 21, chemicals M is injected into the gap P1 between the sleeve 600 and the inner wall through the chemicals injection hole 601 of the repair material. As the chemicals M is being injected into the gap P1, air is forced out from the gap P1 through the air discharge hole 602, as shown by arrows in FIG. 21. When the gap P1 is completely filled with the chemicals M as shown in FIG. 22, the injection is stopped.

As the chemicals M filling in the gap P1 and enclosing the outside of the repair material hardens, the water stopping effect increases. Moreover, strength of the repair material is improved. Since the chemicals M reinforces strength of the repair material, the corrugation 640 can be formed without the risk of deteriorating the strength. Furthermore, owing to the chemicals M, a relatively softer material can be used for the sleeve 600 for more tight contact with the stepped portion in the water pipe P. For the chemicals M, any materials, such as polyester, polyurethane and so on, which are capable of stopping water and reinforcing the repair material can be adopted.

While the invention has been shown and described with reference to preferred embodiments thereof, it will be understood by those skilled in the art that various changes in form and details may be made therein without departing from the spirit and scope of the invention as defined by the appended claims.

### INDUSTRIAL APPLICABILITY

Construction for repairing a water pipe can be performed more quickly with better quality by using the repair material and method according to the present invention. The repair material of the present invention is applicable for even medium or large water pipes requiring urgent repair as well as general water pipes for wastewater and waterworks.

### SEQUENCE LISTING

water pipe, repair material, guide belt

What is claimed is:

1 to 19. (canceled)

20. A reinforcing material for repairing underground water pipeline without excavation is comprised of:
a sleeve, which has forcibly rolled the reinforcing material to form a cylindrical shape for storing resilience force,
a series of guide belts for circumferentially mounting outer surface of the reinforcing material to be easily and conveniently inserted into the water pipeline in a sliding manner,
wherein, the sleeve is inserted into the water pipeline, it is expanded to be tightly sealed a damaged or cracked inner wall area of the water pipeline.

21. The reinforcing material of claim 20, wherein the sleeve further comprises a cut part at one end thereof for penetrating through the guide belt, and the guide belt is welded to the outer surface of the sleeve by only both ends thereof, so that a sliding section is formed between the welded ends for one end of the sleeve to slide along.

22. The reinforcing material of claim 21, wherein the guide belt further comprises a plurality of locking protrusions formed along a length direction for engagement with the one end of the sleeve to prevent the sleeve once expanded from contracting back.

23. The reinforcing material of claim 22, wherein said one end of the sleeve engaged with the locking protrusion is partly curved to protruded outward.

24. The reinforcing material of claim 22, wherein the locking protrusion is formed by partially cutting the guide belt in a trapezoid shape and bending the cut portion inwardly to face the one end of the sleeve.

25. The reinforcing material of claim 22, wherein the end of the outer surface of the sleeve is attached on a locking bar, the end contacted with the guide belt right before the guide belt passes through the cut part, thereby constituting a part of the end of the sleeve.

26. The reinforcing material of claim 21, wherein the guide belt further comprises a plurality of catch holes formed along a length direction, and the sleeve comprises a locking piece protruded from one end thereof to be engaged with the catch holes and restrain the expanded sleeve from contracting back.

27. The reinforcing material of claim 26, wherein the one end of the sleeve formed the locking piece is partly curved to protrude out.

28. The reinforcing material of claim 20, wherein the sleeve has a guide line recessedly formed on an outer surface thereof along a length direction.

29. The reinforcing material of claim 28, wherein the guide belt is disposed within the guide line.

30. The reinforcing material of claim 20, wherein the sleeve comprises a plurality of corrugations formed on the outer surface in a circumferential direction.

31. The reinforcing material of claim 20, wherein the sleeve is attached with a sealing-type water stopping material formed of rubber around the outer surface thereof.

32. The reinforcing material of claim 20, wherein lateral edges of the sleeve are sloped outward so that a diameter of the sleeve increases toward the lateral edges.

33. The reinforcing material of claim 21, wherein the guide belt comprises a plurality of catch holes formed along a length direction, and the sleeve comprises a locking member attached to one end of the outer surface thereof to be engaged with the catch holes and restrain the expanded sleeve from contracting back.

34. The reinforcing material of claim 33, wherein the locking member is engaged with the catch holes from the outside of the guide belt.

35. The reinforcing material of claim 34, wherein the locking member is formed by extending one end of the guide belt.

36. The reinforcing material of claim 20, wherein the sleeve comprises a plurality of corrugations formed on the outer surface in a circumferential direction, an air discharge hole, and chemicals injection hole.

37. A method for repairing underground water pipeline without excavation by inserting reinforcing materials into the water pipeline, the method comprising that:
preparing a sleeve rolled in a cylindrical form for expanding tightly to seal by contacting to a damaged or cracked inner wall area of the water pipeline, wherein the sleeve storing resilience force for spreading when it is pre-rolled up and installing a plurality of corrugations formed in a circumferential direction of the sleeve and mounted a series of guiding belts circumferentially outer surface of the sleeve to guide an end of the sleeve in a sliding manner,
inserting and mounting the repair material inside the water pipeline by expanding the sleeve on a damaged area of the water pipeline,
injecting into a gap between the sleeve and the inner wall of the water pipeline, and
hardening a water-stopping and strength-reinforcing chemicals.

38. A method for repairing underground water pipeline without excavation by inserting reinforcing material into the water pipeline, the method comprising the steps of:
boring a sleeve of the repair material, thereby preparing an air discharge hole and the chemicals injection hole,
mounting the repair material on the outside of a repair tool having an inflatable tool body,
fitting o-rings around both outer ends of the sleeve to seal the gap between the sleeve and the inner wall of the water pipe,
moving the repair tool with the repair material mounted to the tool body to the damaged part of the water pipe,
mounting the repair material in the water pipe by inflating the tool body;
injecting the chemicals into the gap between the sleeve and the inner wall of the water pipe through the chemicals injection hole, and
hardening the injected chemicals.
